(19) United States
(12) Patent Application Publication
(10) Pub. No.: US 2021/0107248 A1
(43) Pub. Date: Apr. 15, 2021

(54) SHAPED CONTAINER FOR STORING FAT-CONTAINING FOOD AND PACKAGE

(71) Applicant: SHOWA DENKO PACKAGING CO., LTD., Isehara-shi (JP)

(72) Inventor: Yuki TANAKA, Isehara-shi (JP)

(73) Assignee: SHOWA DENKO PACKAGING CO., LTD., Isehara-shi (JP)

(21) Appl. No.: 17/066,441

(22) Filed: Oct. 8, 2020

(30) Foreign Application Priority Data
Oct. 9, 2019 (JP) 2019-185760
Sep. 18, 2020 (JP) 2020-157758

(51) Int. Cl. B32B 1/02; B32B 27/32; B32B 15/085; B32B 15/20; B32B 27/28

(52) U.S. Cl. CPC B32B 1/02; B32B 27/32; B32B 15/085; B32B 2307/31; B32B 27/285; B32B 2439/40; B32B 2439/70; B32B 15/20

(57) ABSTRACT

There is provided a shaped container which is unlikely to cause coloring or flavoring even when a processed food product containing a large amount of oil or fat, such as curry or stew, is stored in the container over a long period. The shaped container is formed of a metal laminated packaging material 10 including a heat-fusible resin layer 10a of a homopolypropylene film, a barrier layer 10c of a metal foil, and a protective resin layer 10d of a synthetic resin film, which are laminated in this order. The heat-fusible resin layer 10a forms the inner surface of the shaped container.

### TECHNICAL FIELD

The present invention relates to a shaped container suitable for storage of a fat-containing food, and to a package using the shaped container. Aluminum herein includes pure aluminum and an aluminum alloy unless specified otherwise.

### BACKGROUND ART

Cans and bottles have long been used for long-term storage of a processed food. However, they have problems in transportation or in handling: bottles are heavy and breakable, while there is a possibility of injury from a cut edge after opening of a can. In view of this, shaped containers which use a light and flexible laminated packaging material are widely used.

A metal laminated packaging material (what is called a high barrier film), in which synthetic resin films are laminated on both surfaces of a metal foil, is known as a laminated packaging material. In particular, an aluminum laminated packaging material, in which synthetic resin films are laminated on both surfaces of an aluminum foil, has a high blocking effect against light, moisture, oxygen, etc. Therefore, an aluminum laminated packaging material is advantageously used as a material for a variety of shaped containers (what is called high barrier shaped containers) especially in food application.

Patent document 1, for example, discloses a high barrier shaped container obtained by shaping an aluminum laminated packaging material, which has been produced by dry lamination of a polyethylene terephthalate film, an aluminum foil, a modified polypropylene film and a polypropylene film, such that the polypropylene film forms an innermost surface.

High barrier shaped containers are conventionally used to store a solid or semisolid food product such as a jelly, a pudding or a baby food. On the other hand, a food product containing a large amount of oil or fat (hereinafter also referred to as a fat-containing food), such as curry, stew or pasta sauce, is generally packaged in a pouch-shaped container and distributed as a retort food.

There is a growing demand for retort foods in recent years. Behind the trend are significant changes in consumers' lifestyles, such as the increase in dual-income families, the increase in single-person households, the emergency of the so-called “stay-at-home demand”, etc. However, a retort food in a pouch-shaped container usually needs to be moved to a dish, a bowl, or the like after cooking of the food, thus necessitating the work of washing the dish or the like. Therefore, retort foods are seemingly considered as an annoyance by, in particular, single-person households. Many natural disasters, such as earthquakes, typhoons and floodings, occur worldwide these days. A dish or the like is not always available in a disaster area or in a place of refuge. In this regard, a high barrier shaped container can not only be utilized as a cooking utensil but can also be utilized as it is as a dish or the like. Therefore, the demand for high barrier shaped containers as a convenient means for supplying a retort food is steadily increasing these days.

### CITATION LIST

### Patent Literature

Patent document 1: Japanese Patent No. 2866916

### SUMMARY OF THE INVENTION

### Problem to be Solved by the Invention

However, when a fat-containing food such as curry or stew is stored in a high barrier shaped container over a long period, a coloring component or a flavor component, dissolved in oil or fat, can permeate into a layer forming the innermost surface of the shaped container, causing strong coloring or flavoring. In particular, in the case of a cup-shaped container or a tray-shaped container, the outermost layer of a bent portion is strongly stretched, while the innermost layer is strongly contracted. Strong coloring may occur in such a contracted portion.

### Means for Solving the Problem

It is therefore an object of the present invention to provide a high barrier shaped container using a metal laminated packaging material, which is unlikely to cause the problem of coloring or flavoring especially in a processed portion even when a fat-containing food is stored in the container over a long period.

The present inventors have conceived that if the innermost surface of a shaped container is formed of a synthetic resin film having a uniform and dense crystal structure, a coloring component or a flavor component, contained in a fat-containing food stored in the container, will be unlikely to permeate into the innermost layer. Further, the present inventors have found that by selecting a homopolypropylene film as the synthetic resin film, a shaped container and a package which can solve the above problem can be obtained. Thus, the present invention relates to the following shaped container and package.
1) A shaped container for storing a fat-containing food, comprising a metal laminated packaging material and having an opening and an annular flange portion formed circumferentially around the opening, wherein the metal laminated packaging material comprises a heat-fusible resin layer of a homopolypropylene film, a barrier layer of a metal foil, and a protective resin layer of a synthetic resin film, and wherein the heat-fusible resin layer forms an innermost surface of the container, and the protective resin film forms an outermost surface of the container.
2) The shaped container as described in 1) above, wherein the homopolypropylene film constituting the heat-fusible resin layer has a melting point of not less than 160° C. and a crystal melting energy of not less than 65 J/g.
3) The shaped container as described in 1) or 2) above, wherein the homopolypropylene film constituting the heat-fusible resin layer has a tensile yield stress of not less than 25 MPa.
4) The shaped container as described in any one of 1) to 3) above, further comprising a reinforcing layer of a polyolefin film interposed between the heat-fusible resin layer and the barrier layer.
5) The shaped container as described in 4) above, wherein the polyolefin film constituting the reinforcing layer is a laminated film having at least two layers and comprising at least a poly(propylene-ethylene) random copolymer layer and/or a polypropylene-polyethylene block copolymer layer.
6) The shaped container as described in any one of 1) to 5) above, further comprising an underlayer on one surface or both surfaces of the barrier layer, the underlayer having been formed by a chemical conversion treatment.
7) The shaped container as described in any one of 1) to 6) above, wherein the metal foil constituting the barrier layer is an aluminum foil.
8) The shaped container as described in any one of 1) to 7) above, wherein the synthetic resin film constituting the protective resin layer is a laminated film having at least two layers and comprising at least a poly(propylene-ethylene) random copolymer layer and/or a polypropylene-polyethylene block copolymer layer.
9) The shaped container as described in any one of 1) to 8) above, wherein an opening notch is provided in the upper surface of the flange portion.
10) A heat-sealed package comprising: the shaped container as described in any one of 1) to 9) above; a fat-containing food; and a lid having an innermost surface formed of a heat-fusible resin, wherein a fusion-bonded portion is formed between the heat-fusible resin layer of the lid and the heat-fusible resin layer forming the upper surface of the flange portion of the shaped container.

### Advantageous Effects of the Invention

The shaped container of item 1) is composed of the particular metal laminated packaging material, and therefore has a high blocking effect against moisture, gas, light, etc. Accordingly, the shaped container is suitable for long-term storage of a variety of foods, especially a rich flavored fat-containing food such as curry, stew or pasta sauce. Further, the heat-fusible resin layer forming the innermost surface of the shaped container is formed of a homopolypropylene film having a uniform and dense crystal structure. Oil or fat originating from the fat-containing food hardly permeates into the film. Therefore, even when the fat-containing food is stored in the shaped container over a long period, the fat-containing food is unlikely to cause coloring or flavoring of the container over the entire inner surface. This is prominent especially in a bent portion of the shaped container. Thus, the shaped container of item 1) has good coloring resistance and flavoring resistance.

In the shaped container of item 2), the homopolypropylene film forming the innermost surface of the container has a melting point and a crystal melting energy which are each not less than the predetermined value, and thus has a more uniform and denser crystal structure. Therefore, the shaped container has better coloring resistance and flavoring resistance.

In the shaped container of item 3), the homopolypropylene film forming the innermost surface of the container has a tensile yield stress which is not less than the predetermined value, and thus has a higher strength. Therefore, besides the good coloring resistance and flavoring resistance, the shaped container has excellent mechanical properties such as durability and impact resistance (hereinafter sometimes referred to simply as mechanical properties).

In the shaped container of item 4), the reinforcing layer of a polyolefin film is interposed between the heat-fusible resin layer, forming the innermost surface of the container, and the barrier layer. Therefore, besides the good coloring resistance and flavoring resistance, the shaped container has better mechanical properties. Furthermore, the presence of the reinforcing layer can prevent delamination on one side or both sides of the barrier layer.

In the shaped container of item 5), the polyolefin film constituting the reinforcing layer is a laminated film having at least two layers and comprising at least a poly(propylene-ethylene) random copolymer layer and/or a polypropylene-polyethylene block copolymer layer. Therefore, besides the good coloring resistance and flavoring resistance, the shaped container has good mechanical properties. In addition, the shaped container has enhanced heat resistance and water resistance. Therefore, a package using the shaped container is free of a defect, such as delamination or peeling, in a fusion-bonded portion even after the package is heated in hot water.

In the shaped container of item 6), the underlayer has been formed on one surface or both surfaces of the barrier layer by a chemical conversion treatment. Therefore, when the particular heat-fusible resin layer or the particular reinforcing layer is bonded to the upper surface of the barrier layer with an adhesive, or when the particular protective resin layer is bonded to the lower surface of the barrier layer with an adhesive, the bonded layers exhibit good interlayer adhesion. Therefore, besides the good coloring resistance and flavoring resistance, the shaped container has very good mechanical properties. Furthermore, the shaped container has enhanced heat resistance and water resistance. Therefore, a package using the shaped container is free of a defect, such as delamination or peeling, in a fusion-bonded portion even after the package is heated in hot water. The underlayer itself functions as a barrier layer. Therefore, a package including the shaped container and a fat-containing food stored therein is more suitable for long-term storage of the food.

In the shaped container of item 7), the metal foil constituting the barrier layer is an aluminum foil. The shaped container is therefore lightweight and low-cost. Further, because of good ductility of the aluminum foil, the shaped container is free of cracks or pinholes in the aluminum foil even if the shaped container is one which has been produced by a forming method that involves a large deformation, such as deep draw forming or stretch forming.

In the shaped container of item 8), the synthetic resin film forming the outermost surface of the container is a laminated film having at least two layers and comprising at least a poly(propylene-ethylene) random copolymer layer and/or a polypropylene-polyethylene block copolymer layer. Therefore, besides the good coloring resistance and flavoring resistance, the shaped container has good mechanical properties. In addition, a package using the shaped container is free of a defect, such as delamination or peeling, in a fusion-bonded portion even after the package is heated in hot water.

In the shaped container of item 9), the opening notch is provided around the opening. Therefore, a package comprising the shaped container is easy to open.

In the package of item 10), little color remains in the innermost surface of the shaped container, constituting the main body of the package, when a fat-containing food such as curry, stew or pasta sauce is taken out of the container after long-term storage of the food. This is prominent especially in a bent portion. There is also no residual flavor. Further, depending on the type of the shaped container as the main body, the package is enhanced in part or all of the mechanical properties such as impact resistance and durability, the heat resistance and the water resistance, and the easiness of opening.

### BRIEF DESCRIPTION OF THE DRAWINGS

FIGS. 1(a) and 1(b) are cross-sectional views of an embodiment of a metal laminated packaging material which is to make a shaped container according to the present invention, in which FIG. 1(a) illustrates a basic construction, and FIG. 1(b) illustrates a variation.

FIG. 2 is a perspective view of an embodiment of a shaped container according to the present invention.

FIGS. 3(a) and 3(b) are partial cross-sectional views of an embodiment of a package according to the present invention, FIG. 3(a) illustrating an example in which no opening notch is provided in the upper surface of a flange portion, and FIG. 3(b) illustrating an example in which an opening notch is provided in the upper surface of the flange portion.

### DESCRIPTION OF EMBODIMENTS

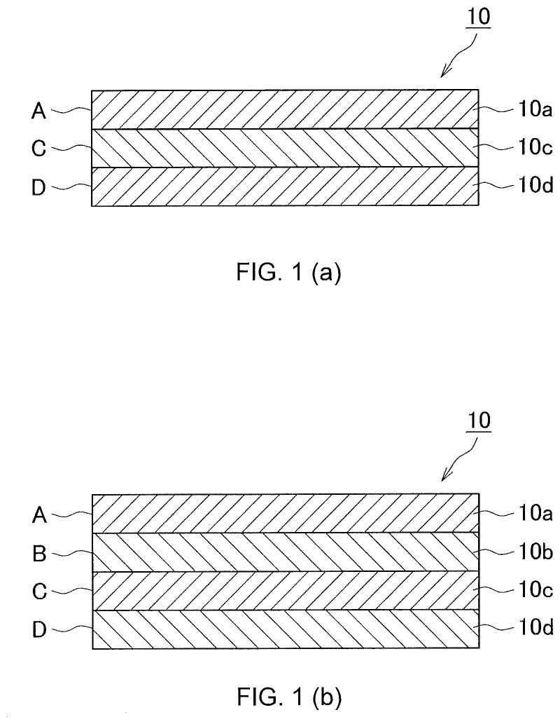

Embodiments of the present invention will now be described with reference to FIGS. 1 through 3. The drawings illustrate the present invention and are not intended to limit the scope of the present invention.

FIGS. 1(a) and 1(b) are cross-sectional views of an embodiment of a metal laminated packaging material (10) which is to make a shaped container (1) according to the present invention. The metal laminated packaging material (10) of FIG. 1(a) consists of a heat-fusible resin layer (10a), a barrier layer (10c), and a protective resin layer (10d) which are laminated in this order. The metal laminated packaging material (10) of FIG. 1(b) consists of the heat-fusible resin layer (10a), a reinforcing layer (10b), the barrier layer (10c), and the protective resin layer (10d) which are laminated in this order. The reinforcing layer (10b) is optional and may be omitted.

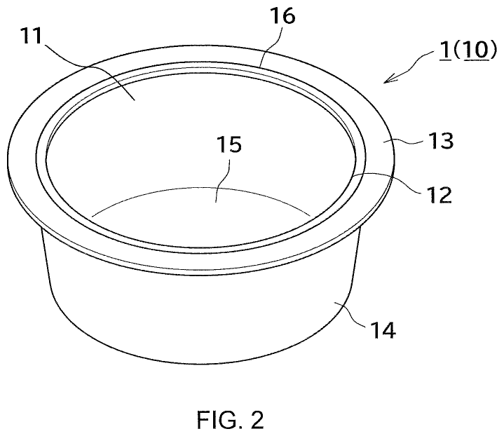

FIG. 2 is a perspective view of an embodiment of the shaped container (1) of the present invention. The shaped container (1) is formed of the metal laminated packaging material (10), and includes a top opening (11), a periphery (12) of the opening (11), an annular flange portion (13) formed around the periphery (12), and a cylindrical side wall (14) connecting with the flange portion (13) via the periphery (12) and extending downward, and a bottom wall (15) surrounded by the side wall (14). An annular opening notch (16) is provided in the upper surface of the flange portion (13).

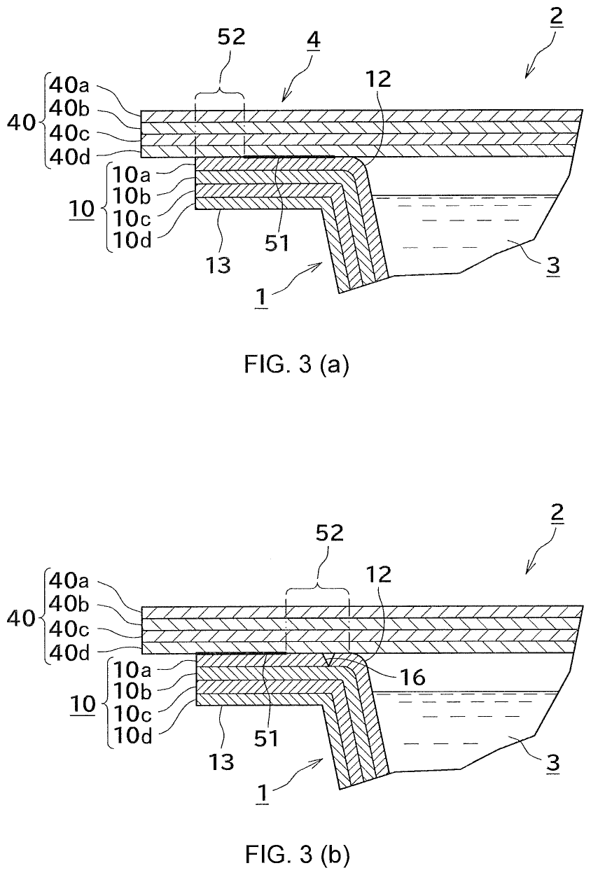

FIGS. 3(a) and 3(b) are cross-sectional views of an embodiment of a package (2) according to the present invention. The package (2) is a heat-sealed body comprising the shaped container (1) of the present invention, a fat-containing food (3) as contents, and a lid (4) as a sealing means.

The heat-fusible resin layer (10a) is a layer which forms the innermost surface of the shaped container (1) and which is to be thermally bonded (fusion-bonded) to the lower surface of the lid (4), and is comprised of a homopolypropylene film (A). The homopolypropylene film (A) is a film made of a propylene homopolymer and has a relatively uniform and dense crystal structure, and therefore has excellent oil resistance. The homopolypropylene film (A) also has good hinge properties; therefore, even when it is deformed upon shaping of the metal laminated packaging material (10), voids are unlikely to form in the film. For the reasons described above, even though the fat-containing food (3) is stored in the shaped container (1), a coloring component and/or a flavor component derived from the fat-containing food (3) hardly permeates into the heat-fusible resin layer (10a). Thus, the shaped container (1) has good coloring resistance and flavoring resistance.

Various known homopolypropylene films can be used as the homopolypropylene film (A). An example is a homopolypropylene film obtained by producing an isotactic homopolypropylene by coordination anionic polymerization of propylene in the presence of a Zeigler catalyst such as titanium(III) chloride-diethylaluminum chloride, and forming the isotactic homopolypropylene into a film. Another example is a homopolypropylene film obtained by producing a homopolypropylene e.g. by a BASE method, an Amoco method, or a UCC method, and forming the homopolypropylene into a film. There is no particular limitation on a method for forming a homopolypropylene into a film; various known methods such as (co)extrusion molding (e.g. inflation extrusion or T-die extrusion), a stretching method, a lamination method, etc. can be used. These methods may be used in a combination thereof. In the case of a stretching method, the homopolypropylene film (A) may be either a stretched type or a non-stretched type. The use of the non-stretched type can enhance the coloring resistance and the flavoring resistance of the shaped container (1).

The more uniform and the denser the crystal structure of the homopolypropylene film (A), the higher the coloring resistance and the flavoring resistance of the shaped container (1). In view of this, the homopolypropylene film (A) preferably has a melting point of not less than 160° C. and a crystal melting energy of not less than 65 J/g. As used herein, the “melting point” refers to a peak melting temperature (Tmp) as measured by differential scanning calorimetry (DSC) according to JIS K 7121-1987. The “crystal melting energy” refers to a peak melting heat (crystal melting energy, ΔH) as measured by DSC according to JIS K 7122-1987. When there is a plurality of peak Tmp values and peak ΔH values, their respective maximum values are to be used. The melting point and the crystal melting energy are preferably 160 to 165° C. and 65 to 80 J/g, respectively. In this case, the shaped container (1) has better coloring resistance and flavoring resistance.

When the homopolypropylene film (A) has a tensile yield stress (hereinafter sometimes abbreviated as TYS) of not less than 25 MPa, the shaped container (1), besides the good coloring resistance and flavoring resistance, has excellent mechanical properties such as impact resistance and durability. As used herein, the “tensile yield stress” refers to a measured value according to JIS K 7127, and is the weighted average value of a TYS in the MD direction and a TYS in the TD direction. The tensile yield stress is preferably 25 to 40 MPa, more preferably 31 to 39 MPa. In this case, the shaped container (1) has better mechanical properties. In this case, the TYS in the MD direction is generally 34 to 40 MPa, while the TYS in the TD direction is generally 28 to 38 MPa.

A film of a polypropylene, which is a copolymer of propylene and a small amount of other α-olefin(s) such as ethylene or 1-butene, may be used as the homopolypropylene film (A) as long as the coloring resistance and the flavoring resistance of the shaped container (1) are not significantly impaired. The α-olefin can be exemplified by ethylene and/or 1-butene. The content of the α-olefin in the homopolypropylene film (A) is less than 10 mol %.

While there is no particular limitation on the thickness of the homopolypropylene film (A), i.e. the thickness of the heat-fusible resin layer (10a), it is generally 20 to 400 μm, preferably 40 to 350 μm in view of the shapability of the metal laminated packaging material (10) as well as the coloring resistance, the flavoring resistance and the heat resistance of the shaped container (1).

An adhesive layer (101) (not shown) may be optionally provided between the heat-fusible resin layer (10a) and the reinforcing layer (10b) or the barrier layer (10c). Various known adhesives can be used as an adhesive which is to make the adhesive layer (101). Examples of usable adhesives include a polyurethane resin adhesive, an acrylic resin adhesive, an epoxy resin adhesive, a polyolefin resin adhesive and an elastomer adhesive. These adhesives may be used singly or in a combination of two or more. Among them, a polyurethane resin adhesive is preferred, and a two-component curable polyether-urethane resin adhesive and/or a two-component curable polyester-urethane resin adhesive is especially preferred. The adhesive may contain the below-described filler e.g. to impart a design to the adhesive layer (101). In particular, the inclusion of a white pigment such as titanium dioxide enables easy detection of foreign matter on the inner surface of the shaped container (1). In view of a balance between such effects and the adhesion strength of the adhesive layer (101), the content of the filler is generally 10 to 60% by weight. There is no particular limitation on the thickness of the adhesive layer (101), and it is generally 1 to 5 μm.

The reinforcing layer (10b), which is an optional layer, is comprised of a known polyolefin film (B). The provision of the reinforcing layer (10b) between the heat-fusible resin layer (10a) and the barrier layer (10c) can enhance the mechanical properties of the shaped container (1) and of the package (2).

Various known polyolefins, including, for example, polyethylene and polypropylene, can be used as a polyolefin which is to make the polyolefin film (B). The polyethylene can be exemplified by a high-density polyethylene, a medium density polyethylene, and a linear low-density polyethylene. The polypropylene can be exemplified by a homopolypropylene, a poly(ethylene-propylene) random copolymer, and a polyethylene-polypropylene block copolymer. The film (B) of a homopolypropylene may be the same as the homopolypropylene film (A). The polyethylene and the polypropylene may each be modified with an unsaturated carboxylic acid such as maleic anhydride or vinyl acetate. There is no particular limitation on a method for forming a polyolefin into a film; various known methods such as (co)extrusion molding (e.g. inflation extrusion or T-die extrusion), a stretching method, a lamination method, etc. can be used. In the case of a stretching method, the polyolefin film (B) may be either a stretched type or a non-stretched type.

The polyolefin film (B) can contain a filler and/or an elastomer. Various known fillers, such as white clay, silica, talc, titanium dioxide and carbon black, can be used as the filler. Such fillers may be used singly or in a combination of two or more. Various known elastomers, such as a styrene elastomer and an olefin elastomer, can be used as the elastomer. Such elastomers may be used either singly or in a combination of two or more.

The shapability of the metal laminated packaging material (10) and the impact resistance of the shaped container (1) are especially good when the polyolefin film (B) is a laminated film having at least two layers and comprising at least a poly(propylene-ethylene) random copolymer layer and/or a polypropylene-polyethylene block copolymer layer. The number of layers of the laminated film may be 2 to 5. An exemplary laminated film is a two- or three-layer polyolefin film comprising a combination of a poly(ethylene-propylene) random copolymer layer and a polyethylene-polypropylene block copolymer layer in an arbitrary order.

While there is no particular limitation on the thickness of the polyolefin film (B), i.e. the thickness of the reinforcing layer (10b), it is generally 20 to 300 μm, preferably 30 to 200 μm in view of the shapability of the metal laminated packaging material (10) as well as the durability, the impact resistance, etc. of the shaped container (1) and of the package (2).

An adhesive layer (102) (not shown) may be optionally provided also between the reinforcing layer (10b) and the barrier layer (10c). The same adhesives as those described above with reference to the adhesive layer (101) can be used as an adhesive which is to make the adhesive layer (102), and a two-component curable polyether-urethane resin adhesive and/or a two-component curable polyester-urethane resin adhesive is especially preferred. The adhesive layer (102) may also contain a filler, which may be selected from the fillers described above with reference to the adhesive layer (101), in the same amount as described above. There is no particular limitation on the thickness of the adhesive layer (102), and it is generally about 1 to 5 μm.

The barrier layer (10c) is a layer for protecting the fat-containing food (3) from gas, steam, light, etc., and is comprised of a metal foil (C). Various known metal foils, such as an aluminum foil, a steel foil, a stainless steel foil, a copper foil and a nickel foil, can be used as the metal foil (C). Among them, an aluminum foil is preferred in terms of the light blocking effect, the barrier function, the shapability, the cost, etc. Further, since an aluminum foil is excellent in ductility, even when the metal laminated packaging material (10), in which the metal foil (C) is an aluminum foil, is subjected to a forming method that involves a large deformation of the material (10), such as deep draw forming or stretch forming, a defect such as a crack or a pinhole is unlikely to be formed in the barrier layer (10c). The aluminum foil can be exemplified by a soft pure aluminum (O material), a soft aluminum alloy foil (O material), a hard aluminum (H18 material) or a hard aluminum alloy foil (H18 material). An Al—Fe alloy foil containing 0.7 to 1.7% of iron is especially preferred. For example, an A1000-series or A8000-series soft material (O material), defined in JIS H 4160, is preferred because it is excellent in the shapability in cold forming such as deep draw forming. The soft material (O material) can be exemplified by an A8021H-O material, an A8079H-O material, and an AlN30-O material. While there is no particular limitation on the thickness of the metal foil (C), i.e. the thickness of the barrier layer (10c), it is generally 50 to 200 μm, preferably 50 to 150 μm from the viewpoint of the above-described defect in the barrier layer (10c) as well as the durability, the impact resistance, etc. of the shaped container (1) and of the package (2).

An underlayer may be formed by a chemical conversion treatment on at least one surface of the barrier layer (10c). The underlayer is formed, for example, by applying a water-alcohol solution, selected from the following group, as a chemical conversion treatment solution onto a surface of the metal foil (C) which has undergone a degreasing treatment:
(i) a water-alcohol solution containing phosphoric acid, chromic acid, and at least one compound selected from the group consisting of a metal salt of a fluoride and a non-metal salt of a fluoride;
(ii) a water-alcohol solution containing phosphoric acid, at least one resin selected from the group consisting of an acrylic resin, a chitosan derivative resin and a phenol resin, and at least one compound selected from the group consisting of chromic acid and a chromium(III) salt; and
(iii) a water-alcohol solution containing phosphoric acid, at least one resin selected from the group consisting of an acrylic resin, a chitosan derivative resin and a phenol resin, at least one compound selected from the group consisting of chromic acid and a chromium(III) salt, and at least one compound selected from the group consisting of a metal salt of a fluoride and a non-metal salt of a fluoride.

There is no particular limitation on the amount of the chemical conversion treatment solution. The chemical conversion treatment solution may be used in such an amount that the amount of chromium, attached to one surface of the barrier layer (10c), is generally 0.1 to 50 mg/m², preferably 2 to 20 mg/m².

An adhesive layer (103) (not shown) may be optionally provided also between the barrier layer (10c) and the protective resin layer (10d). The same adhesives as those described above with reference to the adhesive layer (101) can be used as an adhesive which is to make the adhesive layer (103), and a two-component curable polyether-urethane resin adhesive and/or a two-component curable polyester-urethane resin adhesive is especially preferred. The adhesive layer (103) may also contain a filler, which may be selected from the fillers described above with reference to the adhesive layer (101), in the same amount as described above. There is no particular limitation on the thickness of the adhesive layer (103), and it is generally about 1 to 5 μm.

The protective resin layer (10d) is a layer forming the outermost surface of the shaped container (1), and is a layer for securing the strength of the shaped container (1) and the package (2), and also for protecting the fat-containing food (3), stored in the package (2), from the outside, and is comprised of a known synthetic resin film (D).

Various synthetic resins, including a polyolefin, a polyester and a polyamide, can be used as a synthetic resin which is to make the synthetic resin film (D). The polyolefin can be exemplified by polyethylene and polypropylene. The polyethylene can be exemplified by a high-density polyethylene, a medium density polyethylene, and a linear low-density polyethylene. The polypropylene can be exemplified by a homopolypropylene, a poly(ethylene-propylene) random copolymer, and a polyethylene-polypropylene block copolymer. The film (D) of a homopolypropylene may be the same as the homopolypropylene film (A). The polyethylene and the polypropylene may each be modified with an unsaturated carboxylic acid such as maleic anhydride or vinyl acetate. The polyester can be exemplified by polyethylene terephthalate, polybutylene terephthalate, polyethylene naphthalate, and polybutylene naphthalate. The polyamide can be exemplified by 6-nylon. Other synthetic resins, such as polystyrene, polyvinyl chloride and polycarbonate, can also be used. There is no particular limitation on a method for forming the synthetic resin into the synthetic resin film (D); various known methods such as (co)extrusion molding (e.g. inflation extrusion or T-die extrusion), a stretching method, a lamination method, etc. can be used. In the case of a stretching method, the synthetic resin film (D) may be either a stretched type or a non-stretched type. The synthetic resin film (D) can contain the above-described filler and/or the above-described elastomer.

The shapability of the metal laminated packaging material (10) and the durability of the shaped container (1) are especially good when the synthetic resin film (D) is a laminated film having at least two layers and comprising at least a poly(propylene-ethylene) random copolymer layer and/or a polypropylene-polyethylene block copolymer layer. The number of layers of the laminated film may be 2 to 5. An exemplary laminated film is a two- or three-layer polyolefin film comprising a combination of a poly(ethylene-propylene) random copolymer layer and a polyethylene-polypropylene block copolymer layer in an arbitrary order.

A layer made of an overcoat material, which is a thermosetting curable resin such as an epoxy resin, a chlorinated polyolefin resin, nitrocellulose, an acrylic resin, or a vinyl chloride-vinyl acetate copolymer, may be formed on the surface of the synthetic resin film (D).

While there is no particular limitation on the thickness of the synthetic resin film (D), i.e. the thickness of the protective resin layer (10d), it is generally 15 to 50 μm, preferably 15 to 40 μm in view of the durability, the impact resistance, the weatherability, etc. of the shaped container (1) and of the package (2).

The metal laminated packaging material (10) can be produced by various known methods. Examples may include a dry lamination method, an extrusion lamination method, and a heat lamination method. In the case of a dry lamination method, the above-described adhesives can be used.

The following are preferred embodiments of the metal laminated packaging material (10).

First embodiment: a metal laminated packaging material comprising the heat-fusible resin layer (10a) of a non-stretched homopolypropylene film (having a thickness of 20 to 400 μm, preferably 40 to 350 μm), the barrier layer (10c) of an aluminum foil (in particular A8079H-O material or A8021H-O material according to JIS H 4160) (having a thickness of 50 to 200 μm, preferably 50 to 150 μm) having an underlayer which has been formed on at least one surface by the above-described chemical conversion treatment, and the protective resin layer (10d) of a two- or three-layer polyolefin film (having a total thickness of 15 to 50 μm, preferably 15 to 40 μm) comprising a combination of a poly(ethylene-propylene) random copolymer layer and a polyethylene-polypropylene block copolymer layer in an arbitrary order.

Second embodiment: the metal laminated packaging material according to the first embodiment, further comprising the reinforcing layer (10b) of a two- or three-layer film (having a total thickness of 20 to 300 μm, preferably 30 to 200 μm), comprising a combination of a poly(ethylene-propylene) random copolymer layer and a polyethylene-polypropylene block copolymer layer in an arbitrary order, interposed between the heat-fusible resin layer (10a) and the barrier layer (10c).

The shaped container (1) of the present invention is obtained by shaping the metal laminated packaging material (10) by a known method, including a press forming method such as stretch forming or deep draw forming. In deep draw forming, the metal laminated packaging material (10), which has been cut to a predetermined size, is first set on the upper surface of a fixed female die, with the protective resin layer (10d) in contact with the die. Subsequently, while pressing a movable male die, having the same shape as the storage portion of the shaped container (1), against the metal laminated packaging material (10) from the side of the heat-fusible resin layer (10a), the male die is lowered, thereby performing deep draw forming of the material (10). Next, the male die is raised, and the shaped container (1) is taken out of the fixed female die. The flange portion (13) of the shaped container (1) may be trimmed as necessary to remove an unnecessary portion. The shaped container (1) having a predetermined shape is obtained in this manner.

There is no particular limitation on the shape of the shaped container (1), and it may be appropriately determined depending on the intended use and the design. For example, the opening (11) may have a circular shape, an elliptical shape, a polygonal shape, etc. The flange portion (13) may have a circular ring shape, an elliptical ring shape, a polygonal ring shape, etc. The side wall (14) may have a cylindrical shape, a polygonal prism shape, a tapered shape, etc., and may have a stepped portion and/or an embossed portion at an intermediate position. As with the opening (11), the bottom wall (15) may have a circular shape, an elliptical shape, a polygonal shape, etc. The overall shape of the shaped container (1) is not limited to a cup shape as shown in FIG. 2, and may be, for example, a tray shape. There is no particular limitation on the size of the shaped container (1). In the case of the shaped container (1) having a cup shape as shown in FIG. 2, the width of the flange portion (13) is, for example, about 5 to 10 mm, and the ratio (D/H) between the diameter (D) of the opening (11) and the height (H) of the container is, for example, about 2.

There is no particular limitation on a method for forming the opening notch (16). In an exemplary method, an annular notch-forming blade (not shown), heated e.g. to about 200° C., is pressed against the upper surface of the flange portion (13) to cause the blade edge to permeate into the heat-fusible resin layer (10a), and then the blade edge is pulled out, leaving the opening notch (16) having the same cross-sectional shape as the blade edge. The notch-forming blade can be exemplified by those as described in Japanese Patent Laid-Open Publication No. 2017-30087 and Japanese Utility Model Publication No. H7-20004. There is no particular limitation on the position of the opening notch (16). When the width of the flange portion (13) is 5 to 10 mm, the opening notch (16) may be formed, for example, at a position which is at a distance of 2 to 4 mm from the periphery (12) of the opening (11).

The package (2) of the present invention can be obtained by thermally bonding (fusion-bonding) the lower surface of the lid (4) to the upper surface of the flange portion (13) after putting the fat-containing food (3) in the shaped container (1).

Opening of the package (2) is effected by interfacial peeling that occurs between a heat-fusible resin layer (40d), forming the lower surface of the lid (4), and the heat-fusible resin layer (10a) of the shaped container (1).

FIG. 3(a) is a partial cross-sectional view of the package (2) of the present invention. As shown in FIG. 3(a), an annular fusion-bonded portion (51) has been formed between the lower surface of the lid (4) and the upper surface of the flange portion (13) of the shaped container (1) by the above-described thermal bonding (fusion-bonding). On the other hand, an annular non-fusion-bonded portion (52), which can be used as an opening trigger, is formed outside the fusion-bonded portion (51) (on the opposite side of the fusion-bonded portion (51) from the opening (11)). While there is no particular limitation on the width of the non-fusion-bonded portion (52), it is generally 1 to 3 mm when the width of the flange portion (13) is 5 to 10 mm In this case, the width of the fusion-bonded portion (51) is generally 7 to 9 mm.

In the package (2) shown in FIG. 3(b), the opening notch (16) is provided at a distance from the opening (11) of the shaped container (1). There is no particular limitation on the position of the opening notch (16). When the width of the flange portion (13) is 5 to 10 mm, the opening notch (16) may be formed, for example, at a position which is at a distance of 2 to 4 mm from the periphery (12) of the opening (11). In this case, the width of the fusion-bonded portion (51) is generally 6 to 8 mm. While the opening notch (16) generally has an approximately V-shaped cross-section, it may have, for example, an approximately U-shaped cross-section. When the opening notch (16) has an approximately V-shaped cross-section, no particular limitation is placed on the angle between the two oblique sides, and it is generally 5° to 25°. There is no particular limitation on the position of the front edge of the opening notch (16) as long as it reaches the heat-fusible resin layer (10a) or the reinforcing layer (10b). In the case where the front edge of the opening notch (16) reaches a position (not shown) near the barrier layer (10c), even when peeling of the lid (4) progresses through cohesive failure of the heat-fusible resin layer (10a) and the reinforcing layer (10b), the progress necessarily stops at the position of the opening notch (16). This facilitates opening of the lid (4).

The fat-containing food (3) includes a solid or semisolid processed food product containing an animal or vegetable oil. Examples of such a food product include flavored food products such as curry roux, pasta sauce, stew, demiglace sauce, a processed fish food product (e.g., oil-soaked or boiled tuna, mackerel, saury, sardine, etc.), peanut butter, and a processed meat product (e.g., corned beef or luncheon meat).

The lid (4) is a means for hermetically sealing the fat-containing food (3) in the shaped container (1), and is comprised of a laminated packaging material (40).

The laminated packaging material (40), shown in FIGS. 3(a) and 3(b), consists of a protective resin layer (40a), a metal foil layer (40b), a reinforcing layer (40c), and a heat-fusible resin layer (40d) which are laminated in this order. The metal foil layer (40b) and the reinforcing layer (40c) are optional and may be omitted.

The protective resin layer (40a) is a layer forming the outermost surface of the lid (4), and is comprised of a known synthetic resin film. The various films described above with reference to the synthetic resin film (D) can be used as the synthetic resin film for the protective resin layer (40a). Among them, a film selected from a stretched polypropylene film, a stretched polyethylene terephthalate film and a stretched polyamide film is preferred. The protective resin layer (40a) may be a multi-layer film comprising a combination of two or more synthetic resin films, which may be the same or different from each other, in an arbitrary order. The protective resin layer (40a) may be made of an overcoat material. While there is no particular limitation on the thickness of the protective resin layer (40a), it is generally 1 to 30 μm from the viewpoint of the durability, the impact resistance, the weatherability, etc. of the package (2).

The optional metal foil layer (40b) functions as a barrier layer for protecting the fat-containing food (3), stored in the shaped container (1), from gas, steam, light, etc. The same metal foils as those described above with reference to the metal foil (C) can be used for the metal foil layer (40b). Among them, an aluminum foil is preferred. The aluminum foil can be exemplified by a pure aluminum or aluminum alloy foil which is either an O material or an H18 material. An underlayer may be formed on at least one surface of the metal foil layer (40b) by the above-described chemical conversion treatment. There is no particular limitation on the thickness of the metal foil layer (40b), and it is generally 5 to 40 μm.

The optional reinforcing layer (40c) is comprised of a known synthetic resin film. The provision of the reinforcing layer (40c) between the metal foil layer (40b) and the heat-fusible resin layer (40d) can enhance the strength of the lid (4). Besides the polyolefin film (B), the above-described polyester film and the above-described polyamide film can be used as the synthetic resin film for the reinforcing layer (40c). The reinforcing layer (40c) may be a laminated film composed of two or more layers of synthetic resin films. There is no particular limitation on the thickness of the reinforcing layer (40c), and it is generally 5 to 30 μm.

The heat-fusible resin layer (40d) is a layer which is to be heat-sealed to the heat-fusible resin layer (10a) forming the upper surface of the flange portion (13), and is comprised of a known thermoplastic resin film. Examples of the thermoplastic resin film include a polyethylene film and a polypropylene film as described above with reference to the polyolefin film (B), a polyvinyl alcohol film, an ionomer resin film, and an acrylic copolymer resin film. The thermoplastic resin film can contain the above-described filler and/or the above-described elastomer. The heat-fusible resin layer (40d) may be a multi-layer film comprising a combination of two or more thermoplastic resin films, which may be the same or different from each other, in an arbitrary order. There is no particular limitation on the thickness of the heat-fusible resin layer (40d), and it is generally 10 to 100 μm.

The laminated packaging material (40) can be produced, for example, by a dry lamination method, an extrusion lamination method, or a heat lamination method. In the case of a dry lamination method, the above-described adhesives can be used as an interlayer adhesive.

The lid (4) is obtained by shaping the laminated packaging material (40) into a predetermined shape. There is no particular limitation on the shape of the lid (4); for example, the lid (4) may have a peripheral shape which is the same as or similar to that of the flange portion (13). The lid (4) may optionally have an opening tab. There is no particular limitation on the size and the shape of the opening tab. For example, the opening tab may have a semicircular shape, a triangular shape or a quadrangular shape. The opening tab may be a part of the laminated packaging material (40) constituting the lid (4), or may be separately produced and attached to the peripheral edge of the lid (4).

There is no particular limitation on a method for producing the package (2), and various known methods can be used. In the case of the shaped container (1) of FIG. 2, the package (2) can be produced, for example, by the following method. After putting a predetermined amount of the fat-containing food (3) in the shaped container (1), the lid (4) having a particular shape is placed on the upper surface of the flange portion (13), with the heat-fusible resin layer (40d) facing the flange portion (13). An annular heat sealer, heated to a predetermined temperature, is pressed against a predetermined portion of the lid (4) at a predetermined pressure for a predetermined time to thermally bond (fusion-bond) and heat-seal the heat-fusible resin layer (40d), forming the lower surface of the lid (4), to the heat-fusible resin layer (10a) forming the upper surface of the flange portion (13) of the shaped container (1), thereby obtaining the package (2). The peripheral end of the lid (4) may be trimmed as necessary. In each of the packages (2) of FIGS. 3(a) and 3(b), the annular fusion-bonded portion (51) is formed between the lower surface of the lid (4) and the upper surface of the flange portion (13) in the circumferential direction of the flange portion (13). In the case of the package (2) of FIG. 3(a), the non-fusion-bonded portion (52) having a predetermined width is formed outside the fusion-bonded portion (51) and can be used as an opening trigger. In the case of the package (2) of FIG. 3(b), the opening notch (16) having a certain shape is formed inside the fusion-bonded portion (51) and can be used as an opening trigger.

The package (2) functions as a storage container, as a cooking utensil and as a dish, and therefore has the advantage that after heating the fat-containing food (3) and opening the lid (4), the fat-containing food (3) can be directly eaten.

### EXAMPLES

The following examples illustrate the present invention in greater detail and are not intended to limit the scope of the invention.

The following abbreviations are used in the examples.
Tmp (° C.): melting point (JIS K 7121-1987)
ΔH (J/g): crystal melting energy (JIS K 7122-1987)
TYS (MPa): tensile yield stress (JIS K 7127)
HPP1 to HPP3: homopolypropylene
rPP: poly(ethylene-propylene) random copolymer
bPP: poly(ethylene-propylene) block copolymer
LLDPE: linear low-density polyethylene
PET: polyethylene terephthalate
PU adhesive: two-component curable polyester-polyurethane adhesive

The below-described melting point (Tmp ° C.) values and crystal melting energy (ΔH J/g) values were determined under the following measurement conditions:
Measuring apparatus: differential scanning calorimeter “DSC-60A”, manufactured by Shimadzu Corporation
Amount of sample: 5 mg
Measurement temperature: 23° C. to 210° C.
Rate of temperature increase: 10° C./min

The below-described tensile yield stress (TYS) values were determined by using TENSILON RTG-1210, manufactured by A&D Company, Limited.

Table 1 shows the melting point, the crystal melting energy and the tensile yield stress of each of HPP1, HPP2, HPP3, rPP, bPP and LLDPE.

TABLE 1

| | Tmp | ΔH | TYS(MPa) | | |
|---|---|---|---|---|---|
| | (° C.) | (J/g) | MD | TD | Average |
| HPP1 | 163 | 75 | 33.5 | 31.8 | 32.7 |
| HPP2 | 166 | 79 | 39.4 | 37.6 | 38.5 |
| HPP3 | 165 | 76 | 36.8 | 28.8 | 32.8 |
| rPP | 135 | 18 | 26.4 | 25.3 | 25.9 |
| bPP | 160 | 55 | 6.90 | 6.20 | 6.60 |
| LLDPE | 125 | 120 | 14.3 | 11.8 | 13.1 |

### 1. Production of Aluminum Laminated Packaging Material

### Production Example 1

Both surfaces of a 120 μm-thick aluminum foil (A8079H-O material) were treated with a chemical conversion treatment solution consisting of phosphoric acid, an acrylic resin, a chromate (III) compound, water, and an alcohol to form underlayers on the surfaces, thereby producing a treated aluminum foil. The amount of chromium, attached to one surface of the aluminum foil, was 10 mg/m². Next, a PU adhesive was applied to one surface of the treated aluminum foil such that the thickness of the adhesive coating after drying was 3 μm, and a film of HPP1 (300-μm thick film produced by a T-die method) was attached to the adhesive coating. Next, a PU adhesive was applied to the other surface of the treated aluminum foil such that the thickness of the adhesive coating after drying was 3 μm, and a 30-μm thick non-stretched three-layer co-extruded polyolefin film, consisting of a 4.5-μm thick rPP layer, a 21-μm thick bPP layer and a 4.5-μm thick rPP layer, was attached to the adhesive coating, thereby producing a laminate. Next, the laminate was subjected to aging at 40° C. for 8 days, thereby obtaining an aluminum laminated packaging material A.

### Production Examples 2 and 3

Aluminum laminated packaging materials B and C were produced in the same manner as in Production Example 1 except for using, instead of the film of HPP1, a film of HPP2 (300-μm thick film produced by a T-die method) and a film of HPP3 (300-μm thick film produced by a T-die method), respectively.

### Production Example 4

A PU adhesive was applied to one surface of the treated aluminum foil of Production Example 1 such that the thickness of the adhesive coating after drying was 3 μm, and a 30-μm thick film of rPP was attached to the adhesive coating. Next, a PU adhesive was applied to the surface of the rPP film such that the thickness of the adhesive coating after drying was 3 μm, and the HPP1 film was attached to the adhesive coating. Next, a PU adhesive was applied to the other surface of the treated aluminum foil such that the thickness of the adhesive coating after drying was 3 μm, and the three-layer co-extruded polyolefin film of Production Example 1 was attached to the adhesive coating, thereby producing a laminate. Next, the laminate was subjected to aging under the same conditions as in Production Example 1, thereby obtaining an aluminum laminated packaging material D.

### Production Examples 5 and 6

Aluminum laminated packaging materials E and F were produced in the same manner as in Production Example 4 except for using the HPP2 film and the HPP3 film, respectively, instead of the HPP1 film.

### Production Example 7

A PU adhesive was applied to one surface of the treated aluminum foil of Production Example 1 such that the thickness of the adhesive coating after drying was 3 μm, and a 175-μm thick two-layer co-extruded polyolefin film as a reinforcing layer, consisting of a 150-μm thick bPP layer and a 25-μm thick rPP layer, was attached to the adhesive coating. Next, a PU adhesive was applied to the surface of the two-layer co-extruded polyolefin film such that the thickness of the adhesive coating after drying was 3 μm, and the HPP1 film was attached to the adhesive coating. Next, a PU adhesive was applied to the other surface of the treated aluminum foil such that the thickness of the adhesive coating after drying was 3 μm, and the three-layer co-extruded polyolefin film of Production Example 1 was attached to the adhesive coating, thereby producing a laminate. Next, the laminate was subjected to aging under the same conditions as in Production Example 1, thereby obtaining an aluminum laminated packaging material G.

### Production Examples 8 and 9

Aluminum laminated packaging materials H and I were produced in the same manner as in Production Example 7 except for using the HPP2 film and the HPP3 film, respectively, instead of the HPP1 film.

### Comparative Production Example 1

A PU adhesive was applied to one surface of the treated aluminum foil of Production Example 1 such that the thickness of the adhesive coating after drying was 3 μm, and the (30-μm thick) rPP film of Production Example 4 as a reinforcing layer was attached to the adhesive coating. Next, a PU adhesive was applied to the other surface of the treated aluminum foil such that the thickness of the adhesive coating after drying was 3 μm, and the three-layer co-extruded polyolefin film of Production Example 1 was attached to the adhesive coating, thereby producing a laminate. Next, the laminate was subjected to aging under the same conditions as in Production Example 1, thereby obtaining an aluminum laminated packaging material J.

### Comparative Production Example 2

A PU adhesive was applied to one surface of the treated aluminum foil of Production Example 1 such that the thickness of the adhesive coating after drying was 3 μm, and the two-layer co-extruded polyolefin film of Production Example 7 as a reinforcing layer was attached to the adhesive coating. Next, a PU adhesive was applied to the other surface of the treated aluminum foil such that the thickness of the adhesive coating after drying was 3 μm, and the three-layer co-extruded polyolefin film of Production Example 1 was attached to the adhesive coating, thereby producing a laminate. Next, the laminate was subjected to aging under the same conditions as in Production Example 1, thereby obtaining an aluminum laminated packaging material K.

### Comparative Production Example 3

A PU adhesive was applied to one surface of the treated aluminum foil of Production Example 1 such that the thickness of the adhesive coating after drying was 3 μm, and a 50-μm thick film of LLDPE as a reinforcing layer was attached to the adhesive coating. Next, a PU adhesive was applied to the other surface of the treated aluminum foil such that the thickness of the adhesive coating after drying was 3 μm, and the three-layer co-extruded polyolefin film of Production Example 1 was attached to the adhesive coating, thereby producing a laminate. Next, the laminate was subjected to aging under the same conditions as in Production Example 1, thereby obtaining an aluminum laminated packaging material L.

### 2. Production of Shaped Container

### Example 1

The aluminum laminated packaging material A was set in a commercially available press die machine, and deep draw forming of the aluminum laminated packaging material A was performed, followed by trimming to produce a shaped container A having the shape of a cup as shown in FIG. 2. The shaped container A had the following dimensions: the outer diameter of the flange portion 86 mm; the width of the flange portion 10 mm; the diameter of the opening 66 mm; the height 30 mm; and the diameter of the bottom 56 mm.

### Examples 2 to 6

Shaped container B to F, each having the same dimensions as the shaped container A, were produced in the same manner as in Example 1 except for using the aluminum laminated packaging materials B to F instead of the aluminum laminated packaging material A.

### Example 7

A shaped container having the same dimensions as the shaped container A was produced in the same manner as in Example 1 except for using the aluminum laminated packaging materials G instead of the aluminum laminated packaging material A. Next, an annular notch-forming blade, heated to 200° C., was pressed against the upper surface of the flange portion of the shaped container at a pressure of 120 kgf for 2 seconds to form an annular opening notch, having a generally V-shaped cross-section, at a position which was at a distance of 2 mm from the periphery of the opening, thereby producing a shaped container G. The depth of the notch was 110 μm, and it was considered that the front edge of the notch reached the bPP film layer, constituting a reinforcing layer, as shown in FIG. 3(b).

### Examples 8 and 9

Shaped containers H and I were produced in the same manner as in Example 7 except for using the aluminum laminated packaging materials H and I, respectively, instead of the aluminum laminated packaging material G. The shaped containers H and I each had the same dimensions as the shaped container A. The shape and the dimension of the opening notch, formed in the upper surface of the flange portion of each of the shaped containers H and I, were the same as those of the shaped container A.

### Comparative Examples 1 to 3

Shaped container J, K and L were produced in the same manner as in Example 1 except for using the aluminum laminated packaging materials J, K and L, respectively, instead of the aluminum laminated packaging material A.

FIG. 2 shows the layer structures of the shaped containers A to L.

TABLE 2

| | Examples | | | | | | | | | Comp. Examples | | |
|---|---|---|---|---|---|---|---|---|---|---|---|---|
| | 1 | 2 | 3 | 4 | 5 | 6 | 7 | 8 | 9 | 1 | 2 | 3 |
| Shaped | A | B | C | D | E | F | G | H | I | J | K | L |
| container (1) | | | | | | | | | | | | |
| Homopoly- | HPP | HPP | HPP | HPP | HPP | HPP | HPP | HPP | HPP | | | |
| propylene | 1 | 2 | 3 | 1 | 2 | 3 | 1 | 2 | 3 | | | |
| film (A) | | | | | | | | | | | | |
| Polypropylene | — | | | rPP | | | (bPP/rPP) | | | rPP | (bPP/ | LLD |
| film (B) or other | | | | | | | | | | | rPP) | PE |
| polyolefin film | | | | | | | | | | | | |

| | |
|---|---|
| Metal foil (C) | Treated aluminum foil (chemical conversion treatment) |
| Synthetic resin | (rPP/bPP/rPP) |
| film (D) | |

### 3. Production of Lid

### Production Example 10

Both surfaces of a 12 μm-thick aluminum foil (A8021-H18 material) were treated with the chemical conversion treatment solution of Production Example 1 to form underlayers on the surfaces, thereby producing a treated aluminum foil. The amount of chromium, attached to one surface of the aluminum foil, was 10 mg/m². Next, a PU adhesive was applied to one surface of the treated aluminum foil such that the thickness of the adhesive coating after drying was 3 μm, and a 25-μm thick biaxially oriented PET film was attached to the adhesive coating. Next, a PU adhesive was applied to the other surface of the treated aluminum foil such that the thickness of the adhesive coating after drying was 3 μm, and a 50-μm thick LLDPE film as a heat-fusible resin layer was attached to the adhesive coating, thereby producing a laminate. Next, the laminate was subjected to aging at 40° C. for 8 days, thereby obtaining a laminated packaging material. Next, the laminated packaging material was cut into a 120 mm×120 mm square shape, thereby producing a lid A.

### Production Example 11

A PU adhesive was applied to one surface of the treated aluminum foil of Production Example 10 such that the thickness of the adhesive coating after drying was 3 μm, and a 25-μm thick biaxially oriented PET film as a protective resin layer was attached to the adhesive coating. Next, a PU adhesive was applied to the other surface of the treated aluminum foil such that the thickness of the adhesive coating after drying was 3 μm, and a 12-μm thick biaxially oriented PET film as a reinforcing layer was attached to the adhesive coating. Next, a PU adhesive was applied to the 12-μm thick biaxially oriented PET film as a reinforcing layer such that the thickness of the adhesive coating after drying was 3 μm, and a 50-μm thick LLDPE film as a heat-fusible resin layer was attached to the adhesive coating, thereby producing a laminate. Next, the laminate was subjected to aging under the same conditions as in Production Example 10, thereby producing a laminated packaging material. Subsequently, the laminated packaging material was cut into a 120 mm×120 mm square shape, thereby producing a lid B.

### 4. Production of Package

### Example 10

Two shaped containers A were provided. 20 g of a commercial retort curry roux (“Pro Quality Beef Curry” (registered trademark) medium spicy, manufactured by House Foods Corp.), from which solid ingredients had been removed, was put in one shaped container A, and the lid A was placed on the flange portion. Next, an annular sealer (outer diameter 84 mm, inner diameter 72 mm, width 6 mm), heated to 190° C., was placed down to the flange portion of the container A, such that the center point of the opening of the sealer and the center point of the opening of the shaped container A are aligned on the same imaginary vertical line through the centers, and pressed against the flange portion of the shaped container A at 0.2 MPa for 2 seconds, thereby producing a package A containing the curry roux. 20 ml of water was put in the other shaped container A, and the lid A was heat-sealed to the flange portion of the shaped container A in the same manner and under the same conditions, thereby producing a package A containing water. In each package A, an inner circumferential 6-mm wide zonal area on the upper surface of the flange portion constituted a fusion-bonded portion, while an outer 1-mm wide non-fusion-bonded portion was used as an opening trigger. Further, a 3-mm wide non-fusion-bonded portion was formed inside the fusion-bonded portion on the upper surface of the flange portion.

### Examples 11 to 15

Using the shaped containers B to F, curry roux-containing packages B to F and water-containing packages B to F were produced in the same manner as in Example 10. Each package had the same number of the fusion-bonded and non-fusion-bonded portions of the same sizes as the package A.

### Example 16

Two shaped containers G were provided. 20 g of the above retort curry roux, from which ingredients had been removed, was put in one shaped container G, and the lid B was placed on the flange portion. Next, an annular sealer (outer diameter 86 mm, inner diameter 72 mm, width 7 mm), heated to 190° C., was positioned such that a line perpendicular to the opening of the sealer and passing through the center of the opening passes through the center of the opening of the shaped container G, and pressed against the flange portion of the shaped container G at 0.2 MPa for 2 seconds, thereby producing a package G containing the curry roux. 20 ml of water was put in the other shaped container G, and the lid B was heat-sealed to the flange portion of the shaped container G in the same manner and under the same conditions, thereby producing a package G containing water. In each package G, a circumferential 7-mm wide zonal area on the upper surface of the flange portion constituted a fusion-bonded portion. While no non-fusion-bonded portion was formed outside the fusion-bonded portion, a 3-mm wide non-fusion-bonded portion was formed inside the fusion-bonded portion on the upper surface of the flange portion. The opening notch was located in the non-fusion-bonded portion.

### Examples 17 and 18

Using the shaped containers H and I, curry roux-containing packages H and I and water-containing packages H and I were produced in the same manner as in Example 16. Each package had the same number of the fusion-bonded and non-fusion-bonded portions of the same sizes as the package G.

### Comparative Examples 4 to 6

Using the shaped containers J to L and the lid A, curry roux-containing packages J to L and water-containing packages J to L were produced in the same manner as in Example 10. Each package had the same number of the fusion-bonded and non-fusion-bonded portions of the same sizes as the package A.

### 5. Evaluation of Package

### 5-1. Easiness of Opening, Coloring Resistance and Flavoring Resistance

After allowing the curry roux-containing package A to stand at room temperature for 4 weeks, the package A in a 45-degree tilted position was set in a commercially available tensile tester, and the lid A was pulled upward to measure the strength of the package A. As a result, the strength was found to be about 20 N. Next, the curry roux was discharged from the opened shaped container A, and the interior of the shaped container A was cleansed and then wiped out with a dish cloth. Thereafter, coloring of the side wall, the bottom wall and the corner of the shaped container A and residual flavor in the storage portion of the shaped container A were organoleptically evaluated by the following criteria. The same organoleptic evaluation was performed also for the curry roux-containing packages B to L. The results are shown in Table 3 below.
O: No coloring nor residual flavor was observed in the interior surface of the container.
Δ: Slight coloring was observed only in the corner portion of the interior surface of the container. No flavor was remained.
×: Strong coloring was observed in the bottom wall portion and the corner portion of the interior surface of the container. Residual flavor was also observed.

TABLE 3

| | | Examples | | | | | | | | | Comp. Examples | | |
|---|---|---|---|---|---|---|---|---|---|---|---|---|---|
| | | 10 | 11 | 12 | 13 | 14 | 15 | 16 | 17 | 18 | 4 | 5 | 6 |
| Package (2) | | A | B | C | D | E | F | G | H | I | J | K | L |
| Lid (4) | | A | A | A | A | A | A | B | B | B | A | A | A |
| Shaped | | A | B | C | D | E | F | G | H | I | J | K | L |
| container (1) | | | | | | | | | | | | | |
| Opening | Notch | without | | | | | | with | | | without | | |
| trigger | Non-fusion-bonded | present | | | | | | absent | | | present | | |
| | portion | | | | | | | | | | | | |
| Evaluation | Opening strength | 20N | 20N | 20N | 20N | 20N | 20N | 15N | 15N | 15N | 15N | 20N | 20N |
| | Coloring resistance | ○ | ○ | ○ | ○ | ○ | ○ | ○ | ○ | ○ | X | Δ | X |
| | Flavoring resistance | ○ | ○ | ○ | ○ | ○ | ○ | ○ | ○ | ○ | X | Δ | X |

### 5-2. Presence or Absence of Defect in the Fusion-Bonded Portion After Heating

After heating the curry roux-containing package A in a retort oven (125° C., 20 minutes), the fusion-bonded portion was visually observed from the side of the flange portion. As a result, a defect such as delamination or peeling was not observed. The same evaluation was performed also for the curry roux-containing packages B to L, and no defect was observed.

The data in Table 3 demonstrates that the packages A to I of the Examples, in which the innermost surface of the shaped container as the main body is formed of a homopolypropylene film, have good coloring resistance and flavoring resistance, and also have a non-problematic opening strength. On the other hand, the packages J to L of the Comparative Examples, in which the innermost surface of the shaped container as the main body is formed of a polyolefin which is not homopolypropylene, have poor coloring resistance and flavoring resistance though the opening strength is non-problematic.

### INDUSTRIAL APPLICABILITY

The shaped product of the present invention is suitable for long-term storage of a fat-containing food such as curry, stew or pasta sauce.

### DESCRIPTION OF THE SYMBOLS

(10) metal laminated packaging material
(10a) heat-fusible resin layer
(10b) reinforcing layer
(10c) barrier layer
(10d) protective resin layer
(A) homopolypropylene film
(B) polyolefin film
(C) metal foil
(D) synthetic resin film
(1) shaped container
(11) opening
(12) periphery
(13) flange portion
(14) side wall
(15) bottom wall
(16) opening notch
(2) package
(3) fat-containing food
(4) lid
(40) laminated packaging material
(40a) protective resin layer
(40b) metal foil layer
(40c) reinforcing layer
(40d) heat-fusible resin layer
(51) fusion-bonded portion
(52) non-fusion-bonded portion

What is claimed is:

1. A shaped container for storing a fat-containing food, comprising a metal laminated packaging material and having an opening and an annular flange portion formed circumferentially around the opening, wherein the metal laminated packaging material comprises a heat-fusible resin layer of a homopolypropylene film, a barrier layer of a metal foil, and a protective resin layer of a synthetic resin film, and wherein the heat-fusible resin layer forms an innermost surface of the container, and the protective resin film forms an outermost surface of the container.

2. The shaped container according to claim 1, wherein the homopolypropylene film constituting the heat-fusible resin layer has a melting point of not less than 160° C. and a crystal melting energy of not less than 65 J/g.

3. The shaped container according to claim 1, wherein the homopolypropylene film constituting the heat-fusible resin layer has a tensile yield stress of not less than 25 MPa.

4. The shaped container according to claim 1, further comprising a reinforcing layer of a polyolefin film interposed between the heat-fusible resin layer and the barrier layer.

5. The shaped container according to claim 4, wherein the polyolefin film constituting the reinforcing layer is a laminated film having at least two layers and comprising at least a poly(propylene-ethylene) random copolymer layer and/or a polypropylene-polyethylene block copolymer layer.

6. The shaped container according to claim 1, further comprising an underlayer on one surface or both surfaces of the barrier layer, the underlayer having been formed by a chemical conversion treatment.

7. The shaped container according to claim 1, wherein the metal foil constituting the barrier layer is an aluminum foil.

8. The shaped container according to claim 1, wherein the synthetic resin film constituting the protective resin layer is a laminated film having at least two layers and comprising at least a poly(propylene-ethylene) random copolymer layer and/or a polypropylene-polyethylene block copolymer layer.

9. The shaped container according to claim 1, wherein an opening notch is provided in the upper surface of the flange portion.

10. A heat-sealed package comprising: the shaped container according to claim 1;
a fat-containing food; and a lid having an innermost surface formed of a heat-fusible resin, wherein a fusion-bonded portion is formed between the heat-fusible resin layer of the lid and the heat-fusible resin layer forming the upper surface of the flange portion of the shaped container.
